(19) United States
(12) Patent Application Publication
(10) Pub. No.: US 2015/0090076 A1
(43) Pub. Date: Apr. 2, 2015

(54) Wrench apparatus with sliding bar

(71) Applicants: Allan Ospina, Hallandale Beach, FL (US); Glenn Robinson, Parkland, FL (US); Dan DeLaRosa, Coral Springs, FL (US)

(72) Inventors: Allan Ospina, Hallandale Beach, FL (US); Glenn Robinson, Parkland, FL (US); Dan DeLaRosa, Coral Springs, FL (US)

(21) Appl. No.: 14/121,589

(22) Filed: Sep. 22, 2014

Related U.S. Application Data
(60) Provisional application No. 61/960,851, filed on Sep. 30, 2013.

(51) Int. Cl. B25B 13/16

(52) U.S. Cl. CPC B25B 13/16
USPC 81/157

(57) ABSTRACT

The present invention provides for a wrench apparatus comprising: a shaft with at least one head with an aperture, at least a portion of the shaft has a channel leading to the aperture; a movable element situated within the channel of the shaft and is designed to move within the channel and protrude into the aperture to thereby allow for the adjustment of the size of the aperture.

### RELATED APPLICATION

This application is related to U.S. Provisional Application Ser. No. 61/960,851, entitled “Wrench Apparatus with Sliding Bar” which was filed on Sep. 30, 2013.

### BACKGROUND OF THE INVENTION

### Field of the Invention

This invention relates to a tool and more specifically, to a wrench apparatus with indexing components and a sliding bar.

### SUMMARY OF THE INVENTION

In one embodiment, the present invention provides for a wrench apparatus comprising: an elongated housing having opposing ends, a first end having a head with an aperture and a second end comprising a shaft, at least a portion of the shaft has a channel leading to the aperture within the head; a movable element having a contact surface on one end, at least a portion of the movable element is situated within the channel of the shaft and is designed to move within the channel and allow the contact surface to protrude and retract within the aperture to thereby change the size of the aperture; and a device for allowing a user to move the movable element to adjust the size of the aperture. In another embodiment, the size of the aperture is the circumference of the aperture.

In yet another embodiment, a portion of the aperture comprises a second contact surface. In still another embodiment, the first contact surface comprises at least one insert and at least one spring. In still yet another embodiment, the second contact surface comprises at least one insert and at least one spring.

In a further embodiment, the device comprises a slide mechanism. In another further embodiment, the device comprises a thumb wheel. In yet another further embodiment, the thumb wheel comprises a threaded rod and a wheel. In still another further embodiment, a portion of the shaft functions as a handle. In still yet another embodiment, the slide mechanism comprises a slide track button and at least on spring.

In another embodiment, the aperture is designed to receive nuts, screws, bolts, fasteners, hooks and combinations thereof. In a further embodiment, the wrench is a ratcheting wrench. In another further embodiment, the apparatus further comprises a second head situated opposite of the first head.

In yet another embodiment, the present invention relates to a wrench apparatus comprising: an end segment pivotally attached to a middle segment, the middle segment is pivotally attached to a top segment, and the top segment comprises opposing ends, a first end having a head with an aperture, a second end having a channel leading to the aperture; and a movable element having a first contact surface on one end, at least on portion of the movable element is situated within said channel and is designed to move within the cavity and allow the first contact surface to protrude and retract within the aperture to thereby change the size of the aperture.

In still another embodiment, the apparatus further comprises a device for moving the movable element to allow a user to adjust the size of the aperture. In still yet another embodiment, the device comprises a slide mechanism.

In a further embodiment, the slide mechanism comprises a slide track button and at least one spring.

In another further embodiment, the device comprises a thumb wheel. In yet a further embodiment, the thumb wheel comprises a threaded rod and a wheel.

In still a further embodiment, a portion of said end segment functions as a handle. In still yet further embodiment, a portion of said aperture comprises a second contact surface.

In another embodiment, the first contact surface comprises an insert and a spring. In yet another embodiment, the second contact surface comprises an insert and a spring. In still another embodiment, the apparatus is a ratcheting wrench.

In still yet another embodiment, the end segment comprises one protrusion, the middle segment comprises at least two U-shaped opposing ends, the top segment comprising a protrusion situated opposite of the head. In another embodiment, the protrusions of the end and top segment are positioned between each of the U-shaped ends of the middle segment.

In yet another embodiment, the apparatus further comprises securing mechanism for securing said end segment to the middle segment and said middle segment to the top segment. In still another embodiment, the securing mechanism is selected from a group consisting essentially of nuts, screws, bolts, fasteners, hooks and combinations thereof.

In still yet another embodiment, the apparatus further comprises a detent designed to lock the segment into various positions and angles.

In a further embodiment, the end segment comprises at least one U-shaped end, the middle end comprises a protrusion on one end and a U-shaped end on the other end, and the top segment comprises a protrusion situated opposite of the head.

In another further embodiment, the protrusions of the top and middle segments are positioned within the U-shaped ends of the end and middle segments.

In another embodiment, the apparatus further comprises pins for securing the end segment to the middle segment and the middle segment to the top segment.

In yet another embodiment, the segments are designed to pivot and create various positions and angles.

In still yet another embodiment, the apparatus further comprises a second head with an aperture, and the second head is situated opposite of the first head.

In a further embodiment, the present invention provides a wrench comprising: a handle segment pivotally attached to a top segment, said top segment comprising a head with an aperture and a channel leading to the aperture; a movable element with a first contact surface on one end, at least a portion of the movable element is designed to fit and move within the channel allowing the first contact surface to protrude and retract with the aperture; and a device for moving the movable element to allow a user to change the size of the aperture to accommodate a size of a bolt, nut, screw, bolts, fasteners, hooks and combinations thereof.

In another embodiment, the wrench further comprises a second head with an aperture, said second head being situated opposite of said first head.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of one of the embodiments of the present invention;

FIG. 2 is a perspective view of another embodiment of the present invention;

FIG. 3 is a perspective view of further embodiments; and

FIG. 4 is a perspective view of double headed wrench with sliding bars.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

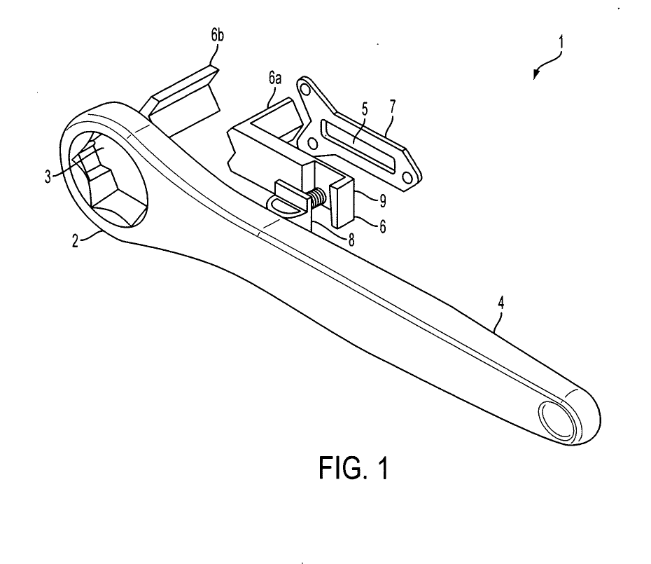

FIG. 1 shows one embodiment of the wrench tool apparatus of the present invention. The wrench 1 comprising a head 2 with an aperture 3 situated on one end of the wrench 1 and a shaft 4 which may function as a handle. The shaft 4 has a channel 5 which leads to the aperture 3 of the head 2. The wrench 1 further comprises movable element 6 with a first contact element 6a and a second contact element 6b. At least a portion of the movable element 6 is situated and movable within the channel 5. The first contact element 6a is designed to protrude through the channel 5 and change the size of the aperture 3. The second contact element 6b may be attached to a portion of the aperture 3. In this embodiment, the slide mechanism is employed. There is a button 8 with a spring 9 attached to the movable element. At least a portion of the button 8 may protrude to the surface of the shaft 4 and may be employed by the user to move the movable element 6 and change the size of the aperture 3. The aperture 3 is designed to receive nuts, screws, bolts, fasteners, hooks, etc. and the head 2 would have the capability of adjusting to the size of the nuts, screw, etc. The is a wall 7 designed to cover the channel 5.

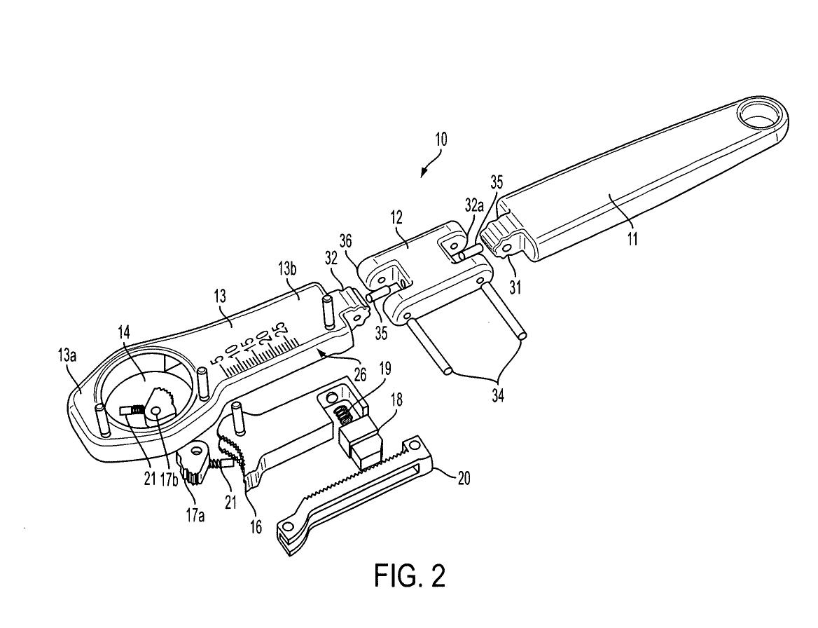

FIG. 2 is an illustration of another embodiment of the present invention. The wrench 10 comprises: an end segment 11 pivotally attached to a middle segment 12, the middle segment 12 is pivotally attached to a top segment 13, and the top segment 13 comprising opposing ends, 13a and 13b respectively. A first end 13a has a head 14 with an aperture 15, and a second end 13b has a channel 26 leading to the aperture 15; and a movable element 16 having a first contact surface 16a on one end, at least a portion of the movable element 16 is situated within the channel 26 and is designed to move within the channel 26 and allow the first contact surface 16a to protrude and retract within the aperture 15 to thereby change the size of the aperture 15.

The movable element 16 has a first insert 17a attached to the contact surface 16a of the first end of the movable element 16; and a button 18 with a spring 19 on an opposing end of the movable element 16. This embodiment may also use a sliding mechanism. There is a second insert 17b attached to a portion of the head 14 protruding into the aperture 15. The inserts, 17a and 17b respectively, have springs 21. The top segment 13 has a cover 22 for keeping the movable element 16 within the channel 26 and closing the channel 26.

The end segment 11 comprises one protrusion 31, and the middle segment 12 comprises at least two U-shaped opposing ends, 32a and 32b, and the top segment 13 comprising a protrusion 33 situated opposite of the head 14. The protrusions, 31 and 33, of the end and top segment, 11 and 13, are positioned between each of the U-shaped ends, 32a and 32b, of the middle segment 12. There are securing mechanisms 34 for securing the end segment 11 to the middle segment 12 and the middle segment 12 to the top segment 13. The securing mechanisms 34 are selected from a group consisting essentially of nuts, screws, bolts, fasteners, hooks and combinations thereof. There are pins 35 that lock the segments, 11, 12 and 13, into various positions. The pivoting capabilities of the wrench 10 allows for indexing of the head 14 and to allow the wrench 10 to create various angles and get into various positions.

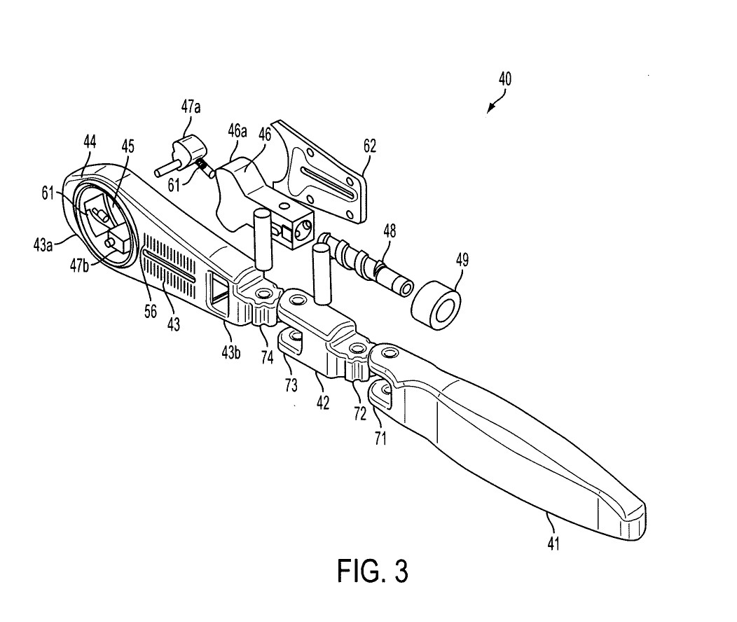

FIG. 3 shows another further embodiment of the present invention which uses a thumb wheel mechanism. The wrench 40 comprises: an end segment 41 pivotally attached to a middle segment 42, the middle segment 42 is pivotally attached to a top segment 43, and the top segment 43 comprising opposing ends, 43a and 43b respectively. A first end 43a has a head 44 with an aperture 45, and a second end 43b has a channel 56 leading to the aperture 45; and a movable element 46 having a first contact surface 46a on one end, at least a portion of the movable element 46 is situated within the channel 56 and is designed to move within the channel 56 and allow the first contact surface 46a to protrude and retract within the aperture 45 to thereby change the size of the aperture 45.

The movable element 46 has a first insert 47a attached to the contact surface 46a of the first end of the movable element 46; and a threaded rod 48 with thumb wheel 49 situated with a cavity 50 on an opposing end of the movable element 46. There is a second insert 47b attached to a portion of the head 44 protruding into the aperture 45. The inserts, 47a and 47b respectively, have springs 61. The top segment 43 has a cover 62 for keeping the movable element 46 within the channel 56 and closing the channel 56.

The end segment 41 comprises at least one U-shaped end 71, and the middle segment 42 comprises a protrusion 72 on one end and a U-shaped end 73 on the other end, and the top segment 43 comprises a protrusion 74 situated opposite of the head 44. The protrusions, 72 and 74, of the top and middle segments, 41 and 42, are positioned within the U-shaped ends, 71 and 73, of the end and middle segments, 41 and 42. The wrench 40 further comprising pins 80 for securing the end segment 41 to the middle segment 42 and the middle segment 42 to the top segment 43.

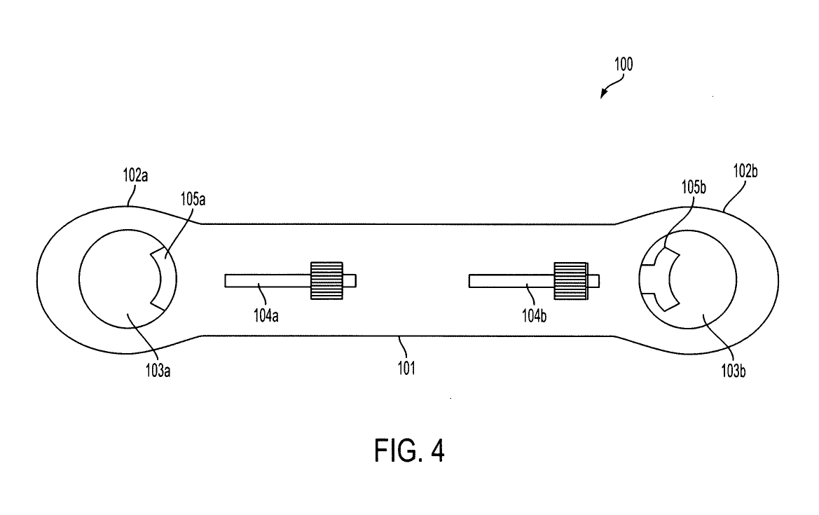

FIG. 4 shows another embodiment of the present invention with a double headed wrench 100. The wrench 100 has a shaft 101 with two heads, 102a and 102b respectively, attached on opposing ends of the shaft 101. The heads, 102a and b, each have apertures, 103a and 103b, There are two channels, 104a and 104b, situated within the shaft 101 and leading to the respective apertures, 103a and 103b. There are two movable elements, 105a and 105b, situated with the channels, 104a and 104b and the elements, 105a and 105b, are designed to move within the channels and at least a portion of the elements, 105a and 105b, may protrude the apertures, 103a and 103b, and allow for the adjustment to the size of the apertures, 103a and 103b, within the heads, 102a and 102b, to accommodate the size of the nuts, screw, bolts, etc. Any mechanism can be used to move the movable elements, 105a and 105b, including, but not limited to the sliding mechanism or the thumb wheel mechanism. Any pivoting mechanism may be employed with the shaft, including but not limited to the pivoting and indexing mechanisms in FIGS. 2-3.

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

1. A wrench apparatus comprising:
an elongated housing having opposing ends, a first end having a head with an aperture and a second end comprising a shaft, at least a portion of said shaft having a channel leading to said aperture within said head;
a movable element having a contact surface on one end, at least a portion of said movable element being situated within said channel of said shaft and is designed to move within said channel and allow said contact surface to protrude and retract within said aperture to thereby change the size of said aperture; and
a device for allowing a user to move said movable element to adjust the size of said aperture.

2. The apparatus of claim 1 wherein a portion of said aperture comprises a second contact surface.

3. The apparatus of claim 1 wherein said first contact surface comprises at least one insert and at least one spring.

4. The apparatus of claim 2 wherein said second contact surface comprises at least one insert and at least one spring.

5. The apparatus of claim 1 wherein said device comprises a slide mechanism.

6. The apparatus of claim 1 wherein said device comprises a thumb wheel.

7. The apparatus of claim 6 wherein said thumb wheel comprises a threaded rod and a wheel.

8. The apparatus of claim 1 wherein a portion of said shaft functions as a handle.

9. The apparatus of claim 5 wherein said slide mechanism comprises a slide track button and at least on spring.

10. The apparatus of claim 1 wherein said aperture is designed to receive nuts, screws, bolts, fasteners, hooks and combinations thereof.

11. The apparatus of claim 1 wherein said wrench is a ratcheting wrench.

12. The apparatus of claim 1 further comprising a second head situated opposite of said first head.

13. A wrench apparatus comprising:
an end segment pivotally attached to a middle segment, said middle segment is pivotally attached to a top segment, said top segment comprising opposing ends, a first end having a head with an aperture, a second end having a channel leading to said aperture; and
a movable element having a first contact surface on one end, at least on portion of said movable element being situated within said channel and is designed to move within said channel and allow said first contact surface to protrude and retract within said aperture to thereby change the size of said aperture.

14. The apparatus of claim 13 further comprising a device for moving said movable element to allow a user to adjust the size of said aperture.

15. The apparatus of claim 14 wherein said device comprises a slide mechanism.

16. The apparatus of claim 15 wherein said slide mechanism comprises a slide track button and at least one spring.

17. The apparatus of claim 14 wherein said device comprises a thumb wheel.

18. The apparatus of claim 17 wherein said thumb wheel comprises a threaded rod and a wheel.

19. The apparatus of claim 13 wherein a portion of said end segment functions as a handle.

20. The apparatus of claim 13 wherein a portion of said aperture comprises a second contact surface.

21. The apparatus of claim 13 wherein said first contact surface comprises an insert and a spring.

22. The apparatus of claim 20 wherein said second contact surface comprises an insert and a spring.

23. The apparatus of claim 13 wherein said apparatus is a ratcheting wrench.

24. The apparatus of claim 13 wherein said end segment comprises one protrusion, said middle segment comprises at least two U-shaped opposing ends, said top segment comprising a protrusion situated opposite of said head.

25. The apparatus of claim 24 wherein said protrusions of said end and top segment are positioned between each of said U-shaped ends of said middle segment.

26. The apparatus of claim 25 further comprising securing mechanism for securing said end segment to said middle segment and said middle segment to said top segment.

27. The apparatus of claim 26 wherein said securing mechanism is selected from a group consisting essentially of nuts, screws, bolts, fasteners, hooks and combinations thereof.

28. The apparatus of claim 26 further comprising a detent designed to lock said segment into various positions and angles.

29. The apparatus of claim 13 wherein said end segment comprises at least one U-shaped end, said middle segment comprises a protrusion on one end and a U-shaped end on the other end, and said top segment comprises a protrusion situated opposite of said head.

30. The apparatus of claim 29 wherein said protrusions of said top and middle segments are positioned within said U-shaped ends of said end and middle segments.

31. The apparatus of claim 30 further comprising pins for securing said end segment to said middle segment and said middle segment to said top segment.

32. The apparatus of claim 31 wherein said segments are designed to pivot and create various positions and angles.

33. The apparatus of claim 13 further comprising a second head with an aperture, said second head being situated opposite of said first head.

34. A wrench comprising:
a handle segment pivotally attached to a top segment, said top segment comprising a head with an aperture and a channel leading to said aperture;
a movable element with a first contact surface on one end, at least a portion of said movable element is designed to fit and move within said channel allowing said first contact surface to protrude and retract with said aperture; and
a device for moving said movable element to allow a user to change the size of said aperture to accommodate a size of a bolt, nut, screw, bolts, fasteners, hooks and combinations thereof.

35. The wrench of claim 34 further comprising a second head with an aperture, said second head being situated opposite of said first head.
